(19) United States
(12) Patent Application Publication
(10) Pub. No.: US 2016/0233485 A1
(43) Pub. Date: Aug. 11, 2016

(54) LITHIUM ION SECONDARY CELL

(71) Applicant: KABUSHIKI KAISHA TOYOTA JIDOSHOKKI, Kariya-shi, Aichi (JP)

(72) Inventors: Nagisa WATANABE, Kariya-shi (JP); Junichi NIWA, Kariya-shi (JP)

(73) Assignee: KABUSHIKI KAISHA TOYOTA JIDOSHOKKI, Kariya-shi, Aichi (JP)

(21) Appl. No.: 15/022,245

(22) PCT Filed: May 23, 2014
(86) PCT No.: PCT/JP2014/063740

§ 371 Date: Mar. 16, 2016

(30) Foreign Application Priority Data
Sep. 17, 2013 (JP) 2013-192275

(51) Int. Cl. H01M 4/133; H01M 4/36; H01M 4/485; H01M 4/66; H01M 4/505; H01M 4/587; H01M 4/62; H01M 4/131; H01M 4/525

(52) U.S. Cl. CPC H01M 4/133; H01M 4/131; H01M 4/364; H01M 4/485; H01M 4/525; H01M 4/505; H01M 4/587; H01M 4/625; H01M 4/621; H01M 4/623; H01M 4/661; H01M 2004/027

(57) ABSTRACT

A lithium ion secondary cell comprises a negative electrode mixture layer containing 5 to 45% by mass of at least one negative electrode active material selected from the group consisting of hard carbon, soft carbon, Sn, Sn alloys, Si, Si alloys, SiOx (0<x<2), Ge, Ge alloys, carbon nanotubes, and carbon nanofibers, and a positive electrode mixture layer containing a lithium-containing transition metal oxide. The negative electrode mixture layer satisfies (Initial charge capacity per unit mass of the negative electrode mixture layer)/(Initial discharge capacity per unit mass of the negative electrode mixture layer)≧1.3.

### TECHNICAL FIELD

The present invention relates to a lithium ion secondary cell.

### BACKGROUND ART

Conventionally, lithium ion secondary cells have been employed in hybrid automobiles, electric automobiles and the like. From such lithium ion secondary cells for automobiles, rapid discharge characteristics are particularly required.

### CITATION LIST

### Patent Literature

Patent Literature 1: Japanese Patent No. 4219391

Patent Literature 2: Japanese Unexamined Patent Publication No. 2009-252705

### SUMMARY OF INVENTION

### Technical Problem

However, with conventional lithium ion secondary cells, rapid discharge characteristics are not sufficient.

The present invention has been made in consideration of the problem described above, and has an object to provide a method for producing a lithium ion secondary cell excellent in rapid discharge characteristics.

### Solution to Problem

The lithium ion secondary cell according to the present invention comprises a negative electrode mixture layer that satisfies the following formula and a positive electrode mixture layer that contains a lithium-containing transition metal oxide.

(Initial charge capacity per unit mass of the negative electrode mixture layer)/(Initial discharge capacity per unit mass of the negative electrode mixture layer)≧1.3

Then, the negative electrode mixture layer contains 5 to 45% by mass of at least one negative electrode active material selected from the group consisting of hard carbon, soft carbon, Sn, Sn alloys, Si, Si alloys, SiOₓ (0<x<2), Ge, Ge alloys, carbon nanotubes, and carbon nanofibers.

Also, it is preferable that the negative electrode mixture layer further contain 105 to 500 parts by mass of graphite based on 100 parts by weight of the negative electrode active material.

Also, it is preferable that a negative electrode active material other than the graphite be SiOₓ (0<x<2).

### Advantageous Effects of Invention

According to the present invention, a lithium ion secondary cell excellent in rapid discharge characteristics is provided.

### BRIEF DESCRIPTION OF DRAWINGS

FIG. 1 is a schematic cross-sectional view of a lithium ion secondary cell according to one embodiment of the present invention.

### DESCRIPTION OF EMBODIMENTS

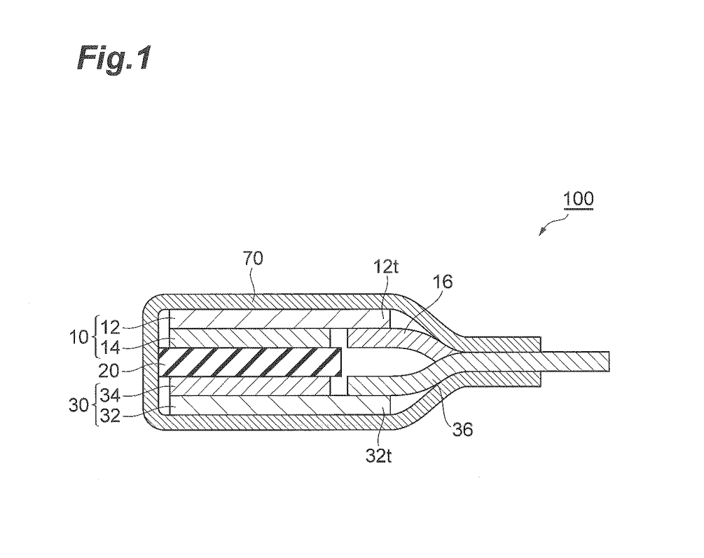

Hereinafter, one example of an embodiment according to the present invention will be described with referring to the drawing. FIG. 1 is a schematic cross-sectional view of a lithium ion secondary cell 100 according to the present embodiment. As shown in FIG. 1, the lithium ion secondary cell 100 mainly comprises a positive electrode 10, a separator 20, a negative electrode 30 and a case 70, and a liquid electrolyte.

(Positive Electrode)

The positive electrode 10 includes a positive electrode collector 12, and a positive electrode mixture layer 14 provided on the positive electrode collector 12. The positive electrode mixture layer 14 may be provided on only one side of the positive electrode collector 12, as shown in FIG. 1, or may be provided on each side of the positive electrode collector 12.

The positive electrode collector 12 is made of an electrically conductive material. Examples of the material of the positive electrode collector 12 include metal materials such as stainless steel, titanium, nickel, and aluminum or electrically conductive resins. Particularly, as the material of the positive electrode collector 12, aluminum is suitable. The thickness of the positive electrode collector 12 is not particularly limited, and for example, can be a foil form (15 to 20 μm).

The positive electrode mixture layer 14 contains a positive electrode active material and a binder. The positive electrode active material is a lithium-containing transition metal oxide. Examples of the lithium-containing transition metal oxide include mixed oxides containing at least one element selected from the group consisting of Ni, Mn, and Co; and Li. Examples of the mixed oxide include a lithium-cobalt mixed oxide LiCoO₂, a lithium-nickel mixed oxide LiNiO₂, lithium-manganese mixed oxides LiMnO₂ and LiMn₂O₄, lithium-nickel-cobalt mixed oxides LiNiₐCo_{b}O₂ (a+b=1, 0<a<1, 0<b<1), lithium-manganese-cobalt mixed oxides LiMnₐCo_{b}O₂ (a+b=1, 0<a<1, 0<b<1), and lithium-cobalt-nickel-manganese mixed oxides LiCoₚNi_{q}MnᵣO₂ (p+q+r=1, 0<p<1, 0<q<1, 0<r<1). Examples of the mixed oxide include LiCo_{1/3}Ni_{1/3}Mn_{1/3}O₂, LiNi_{0.6}Co_{0.2}Mn_{0.2}O₂, LiNi_{0.5}CO_{0.2}Mn_{0.3}O₂, LiCoO₂, LiNi_{0.8}Co_{0.2}O₂, and LiCoMnO₂.

Alternatively, the positive electrode active material can also be a lithium-containing transition metal oxide represented by the formula: LiCoₚNi_{q}MnᵣDₛO₂ (p+q+r+s=1, 0<p≦1, 0≦q<1, 0≦r<1, 0<s<1). D is at least one element selected from the group consisting of Al, Mg, Ti, Sn, Zn, W, Zr, Mo, Fe, and Na.

Alternatively, as the positive electrode active material, it is possible to use oxide solid solutions that contain any of Li₂MnO₃, LiFePO₄, LiMnPO₄, Li₂FeP₂O₇, Li₂FeSiO₄, Li₂MnSiO₄, LiNi_{0.5}Mn_{1.5}O₄, and the aforementioned oxides.

A binder is a resin that is blended to fix the active material to the collector. Examples of the binder include fluorine-containing resins such as polyvinylidene fluoride, polytetrafluoroethylene, and fluorine rubber; thermoplastic resins such as polypropylenes and polyethylenes; imide-based resins such as polyimides and polyamideimides; and alkoxysilyl group-containing resins. The amount of the binder can be 1 to 30 parts by mass based on 100 parts by mass of the active material.

The positive electrode mixture layer 14 can further contain a conductive assistant as required. Examples of the conductive assistant include carbon-based particles such as carbon black, graphite, acetylene black (AB), Ketjenblack (registered trademark) (KB), and vapor grown carbon fibers (VGCFs). These can be added singly, or two or more of these can be added in combination. The amount of the conductive assistant used is not particularly limited, and for example, can be 1 to 30 parts by mass based on 100 parts by mass of the active material.

The positive electrode collector 12 has a tab portion 12t on an end of which the positive electrode mixture layer 14 is not formed. To the tab portion 12t, a lead 16 described below is electrically connected.

(Negative Electrode)

The negative electrode 30 comprises a negative electrode collector 32, and a negative electrode mixture layer 34 provided on the negative electrode collector 32. The negative electrode collector 32 is made of an electrically conductive material. As the material of the negative electrode collector 32, metals that are not alloyed with lithium can be used, and particularly, copper is preferable. The negative electrode collector 32 can be a foil form as the positive electrode collector 12.

The negative electrode mixture layer 34 contains a negative electrode active material and a binder. The negative electrode mixture layer 34 may contain a conductive assistant as required. Examples of the binder and the conductive assistant can be similar to those described in the positive electrode 10. The amount of the binder can be 1 to 30 parts by mass based on 100 parts by mass of the negative electrode active material. The amount of the conductive assistant can be 1 to 30 parts by mass based on 100 parts by mass of negative electrode active material.

In the present embodiment, the negative electrode mixture layer 34 contains 5 to 45% by mass of at least one negative electrode active material selected from the group consisting of hardly-graphitizable carbon (hard carbon), easily-graphitizable carbon (soft carbon), Sn, Sn alloys, Si, Si alloys, SiOₓ (0<x<2), Ge, Ge alloys, carbon nanotubes, and carbon nanofibers. A combination of a plurality among these negative electrode active materials also can be used. The initial charge capacity/initial discharge capacity of these negative electrode active materials can be 1.3 or more.

The hardly-graphitizable carbon (hard carbon) is the generic name of carbons that form a crystalline structure in which the average surface interval d₀₀₂ of the surface (002) exceeds 3.40 Å when thermally treated at 2500° C. in an inert atmosphere. The hard carbon can be obtained by calcining, for example, a thermosetting resin such as a phenolic resin, a melamine resin, a urea resin, a furane resin, an epoxy resin, an alkyd resin, an unsaturated polyester resin, a diallyl phthalate resin, a furfural resin, a resorcinol resin, a silicone resin, a xylene resin, and a urethane resin, and hardly-graphitizable coke.

The easily-graphitizable carbon (soft carbon) is a generic name of carbons that form a crystalline structure in which the average surface interval d₀₀₂ of the surface (002) is 3.40 Å or less, preferably from 3.35 to 3.40 Å, when thermally treated at 2000 to 3000° C. in an inert atmosphere. The soft carbon is a carbon material obtained by calcining a polymer from which a graphite crystalline structure is likely to develop by a high temperature treatment, for example, a curable resin, a thermoplastic resin, petroleum-based or coal-based tar or pitch, and furthermore, a compound prepared by crosslinking the tar, pitch or the like. The soft carbon can be obtained by calcining, for example, pitch such as petroleum-based pitch, coal-based pitch, and mesophase-based pitch; and easily-graphitizable coke such as petroleum-based needle coke, coal-based needle coke, anthracene, polyvinyl chloride, and polyacrylonitrile.

Examples of the Sn alloy include Sn—Ni alloys, Sn—Zn alloys, P—Sn alloys, Sn—Cu alloys, and Sn—Ag alloys.

Examples of the Si alloy include Si—Cu alloys, Si—Co alloys, and Si—Cr alloys.

SiOₓ is a silicon oxide represented by the composition SiOₓ (0<x<2). If x is less than 0.5, volume changes on charging and discharging become too large because the ratio of the Si phase becomes higher, and the cycling characteristics tend to hardly increase. Alternatively, if x exceeds 1.5, the ratio of the Si phase decreases, and there may be a case where the energy density decreases. Accordingly, it is preferable that x be 0.5 to 1.5, and it is more preferable that x be 0.7 to 1.2.

Examples of the Ge alloy include Si—Ge alloys, Si—Ge—Ti alloys, and Ge—Cr alloys.

The carbon nanotube is tubular carbon which is formed from a monolayer or multilayer graphene sheet and of which diameter is about 100 nm or less.

The carbon nanofiber is fibrous carbon fiber which is formed by laminating graphene sheet and of which diameter is about 100 nm or less.

TABLE 1

| | | Initial | | Initial |
|---|---|---|---|---|
| | | discharge | | charge |
| Negative | Initial charge | capacity of | Irreversible | capacity/ |
| electrode | capacity of the | the active | capacity of the | Initial |
| active | active material | material | active material | discharge |
| material | (mAh/g) | (mAh/g) | (mAh/g) | capacity |
| Graphite | 370 | 330 | 40 | 1.1 |
| Hard carbon | 500 | 400 | 100 | 1.3 |
| Soft carbon | 400 | 300 | 70 | 1.3 |
| Sn | 950 | 600 | 350 | 1.6 |
| Si | 4000 | 2500 | 1500 | 1.6 |
| SiOₓ | 2500 | 1500 | 1000 | 1.7 |
| Ge | 1500 | 900 | 600 | 1.7 |

In Table 1, the approximate initial charge capacity (per unit mass), initial discharge capacity (per unit mass), irreversible capacity, and (initial charge capacity/initial discharge capacity) of each material are shown. It should be noted that the initial charge capacity and initial discharge capacity can be measured for each negative electrode active material using metal lithium as a counter electrode. In a cell in which the positive electrode that contains the lithium-containing transition metal oxide or the like is used as the counter electrode, the negative electrode containing a negative electrode active material stores lithium ions on charging and releases lithium ions on discharging. However, in the cell in which metal lithium is used as the counter electrode, since the standard electrode potential becomes lower in metal lithium than in the negative electrode, the negative electrode stores lithium ions on discharging and releases lithium ions on charging. Accordingly, in the case where metal lithium is used as the counter electrode, the capacity on the initial discharging (on storing lithium ions in the negative electrode) will be the initial charge capacity of the negative electrode, and the capacity on the initial charging (on releasing lithium ions from the negative electrode) will be the initial discharge capacity of the negative electrode.

The particle size of the negative electrode active material is not particularly limited, but the average particle size D50 can be 10 μm or less. The average particle size D50 may be 1 nm or more. The average particle size D50 is a median diameter and can be obtained based on a volume-basis particle size distribution by the laser diffraction method.

The negative electrode mixture layer can contain graphite in addition to the negative electrode active material. The graphite is a carbon material having a graphite structure and functions as a negative electrode active material. By adding graphite, (Initial charge capacity per unit mass of the negative electrode mixture layer)/(Initial discharge capacity per unit mass of the negative electrode mixture layer) described below can be adjusted. The average particle size D50 of the graphite particles is not particularly limited, but is preferably from 1 to 50 μm. The graphite may be artificial graphite or natural graphite. The amount of the graphite is not particularly limited, but, in the negative electrode mixture layer, it is preferable to contain from 105 to 500 parts by mass, it is more preferable to contain from 110 to 450 parts by mass, based on 100 parts by weight of the negative electrode active material.

In the present embodiment, the negative electrode mixture layer 34 satisfies the following formula.

(Initial charge capacity per unit mass of the negative electrode mixture layer)/(Initial discharge capacity per unit mass of the negative electrode mixture layer)≧1.3

The initial charge capacity per unit mass of the negative electrode mixture layer and the initial discharge capacity per unit mass of the negative electrode mixture layer can be determined by charging and discharging the negative electrode before charging using the lithium counter electrode. Alternatively, by calculating the total initial discharge capacity and the total initial charge capacity of the total active materials including graphite by use of Table 1 and dividing the capacities by the mass of the total negative electrode active materials including the conductive assistant and the binder, it is possible to determine (Initial charge capacity per unit mass of the negative electrode mixture layer)/(Initial discharge capacity per unit mass of the negative electrode mixture layer).

By using the negative electrode mixture layer 34 satisfying Initial charge capacity/Initial discharge capacity≧1.3, it is possible to provide a lithium ion secondary cell excellent in rapid discharge characteristics. Meanwhile, when the proportion of negative electrode active materials other than the graphite in the negative electrode mixture layer becomes too large, the discharge capacity of the lithium ion secondary cell tends to decrease, and the proportion of negative electrode active materials other than graphite in the negative electrode mixture layer is from 5 to 45% by mass, and preferably 10 to 40% by weight.

The negative electrode collector 32 has a tab portion 32t on an end of which the negative electrode mixture layer 34 is not formed. To the tab portion 32t, a lead 36 described below is electrically connected. It is also possible for the negative electrode to contain a negative electrode active material other than the above.

(Separator)

The separator 20 separates the positive electrode 10 and the negative electrode 30 to prevent short-circuit of current by contact of both electrodes while allowing lithium ions to pass. As the separator 20, for example, porous films made of a synthetic resin such as polytetrafluoroethylene, polypropylene, or polyethylene or porous films made of ceramic can be used. Alternatively, non-woven fabrics made of polyethylene terephthalate, polyvinyl alcohol, polyacrylonitrile, and cellulose can be used.

(Liquid Electrolyte)

A liquid electrolyte contains an electrolyte and a solvent that dissolves the electrolyte. The positive electrode mixture layer 14, the separator 20, and the negative electrode mixture layer 34 are impregnated internally with the electrolyte.

As examples of the electrolyte, salts generally used in lithium ion cells can be used. The examples include lithium salts such as LiBF₄, LiPF₆, LiClO₄, LiAsF₆, LiCF₃SO₃, and LiN(CF₃SO₂)₂. These lithium salts may be used singly, or two or more of the lithium salts may be used in combination.

Examples of the solvent include cyclic esters, chain esters, and ethers. Two or more of these solvents can be mixed. Examples of the cyclic esters include ethylene carbonate, propylene carbonate, butylene carbonate, gamma-butyrolactone, vinylene carbonate, 2-methyl-gamma-butyrolactone, acetyl-gamma-butyrolactone, and gamma-valerolactone. Example of the chain esters include dimethyl carbonate, diethyl carbonate, dibutyl carbonate, dipropyl carbonate, ethylmethyl carbonate, alkyl propionate esters, dialkyl malonate esters, and alkyl acetate esters. Examples of the ethers include tetrahydrofuran, 2-methyltetrahydrofuran, 1,4-dioxane, 1,2-dimethoxyethane, 1,2-diethoxyethane, and 1,2-dibutoxyethane.

The concentration of the electrolyte in the liquid electrolyte can be 0.5 to 1.7 mol/L, for example. The liquid electrolyte may contain a gelling agent.

(Case)

A case 70 accommodates the positive electrode 10, the separator 20, the negative electrode 30, and the liquid electrolyte. The material and form of the case are not particularly limited, and known various substances such as resins and metals can be used.

To the tab portion 12t of the positive electrode collector 12 and the tab portion 32t of the negative electrode collector 32, leads 16 and 36 are connected, respectively. One end of each of the leads 16 and 36 is external to the case 70.

(Function and Effect)

The lithium ion secondary cell according to the present embodiment is excellent in rapid discharge characteristics from the state of charge (SOC) of 50% or less. The reason why such characteristics can be obtained is unclear, but it is believed as follows: in the cell according to the present embodiment, the irreversible capacity is large; and compared with conventional lithium ion secondary cells of which irreversible capacity is small, the amount of lithium ions that have returned into the positive electrode is small even in the region with the SOC of 50% or less, which results in a small positive electrode resistance.

### EXAMPLES

### Example 1

SiOₓ (average particle size D50=5 μm, x=1.0):natural graphite (average particle size D50=20 μm):acetylene black:polyimide were mixed in a proportion of 32:50:8:10 and diluted with NMP to prepare paste. This paste was applied on Cu foil of 20 μm in thickness. After drying, the mixture layer was pressed to about 1.1 g/cm³ (except the Al foil) and thermally treated at 200° C. for 2 hours to prepare a negative electrode.

Li(Ni_{0.5}Co_{0.2}Mn_{0.3})O₂ (average particle size D50=10 μm):acetylene black:PVdF were mixed in a proportion of 94:3:3 (wt %) and diluted with NMP to prepare paste. This paste was applied on 20 μm Al foil. After drying, the mixture layer was pressed to approximately 3.0 g/cm³ (except the Al foil) and thermally treated at 120° C. for 6 hours to prepare a positive electrode. The coating weight of the positive electrode was made to be 6.0 mg/cm², and the coating weight of the negative electrode was made to be 1.0 mg/cm². A pair of the positive electrode and the negative electrode obtained was used to prepare a cell of which opposing area was 7.5 cm².

The liquid electrolyte contains a solvent of a volume ratio of EC:DEC=3:7 and 1M LiPF₆. The separator was a monolayer polyethylene porous film of 20 μm in thickness. The cell prepared was CCCV charged at 0.8 C to 4.2 V for two hours, degassed, and subjected to 30 cycles of CC charging and discharging at 1 C from 3.0 to 4.2 V to obtain a cell to be evaluated. Based on the initial charging and discharging, Initial charge capacity/Initial discharge capacity of the negative electrode mixture layer was determined. Additionally, the charging and discharging operation and the output evaluation described below were both performed at 25° C.

### Example 2

A negative electrode was prepared as described in Example 1 except that SiOₓ (average particle size D50=5 μm, x=1.0):natural graphite (average particle size D50=20 μm):acetylene black:polyimide were mixed in a proportion of 16:66:8:10 and that the coating weight of the negative electrode was 1.5 mg/cm².

### Comparative Example 1

A negative electrode was prepared as in Examples except that natural graphite:acetylene black:polyimide=82:8:10 (wt %) and that the coating weight of the negative electrode was 3.1 mg/cm².

(Evaluation)

The open circuit potential (OCV) was measured by charging and discharging each cell in the range of 2.5 to 4.2 V to determine the potential at which the SOC reached 50%. Then, discharging was performed once at 1 C to 2.5 V, and subsequently, CCCV charging was performed at 1 C for two hours to the potential at which the SOC reached 50%. From the potential at which the SOC reached 50%, discharging was performed plural times with the output varied under constant output discharging to 2.5 V. From the relationship between the discharged electric power value then and the time, the 10-second output, that is, the electric power that can be outputted in 10 seconds was determined. The results are shown in Table 2.

The cells of Examples were larger in the 10-second output than the cell of Comparative Example.

TABLE 2

| | | Ex- | Ex- | Comparative |
|---|---|---|---|---|
| | | ample 1 | ample 2 | Example 1 |
| Negative | Graphite (% by mass) | 50 | 66 | 82 |
| electrode | SiOₓ (% by mass) | 32 | 16 | 0 |
| active | AB (% by mass) | 8 | 8 | 8 |
| material | Polyimide (% by mass) | 10 | 10 | 10 |
| layer | | | | |

| | | | |
|---|---|---|---|
| Parts by mass of graphite based on 100 | 156.3 | 412.5 | — |
| parts by mass of SiOₓ | | | |
| Coating weight of the negative | 1.0 | 1.5 | 3.1 |
| electrode active material layer | | | |
| (mg/cm²) | | | |
| Initial charge capacity per unit mass of | 1006 | 671 | 337 |
| the negative electrode active material | | | |
| layer (mAh/g) | | | |
| Initial discharge capacity per unit mass | 665 | 484 | 303 |
| of the negative electrode active material | | | |
| layer (mAh/g) | | | |
| Irreversible capacity per unit mass of | 341 | 187 | 34 |
| the negative electrode active material | | | |
| layer (mAh/g) | | | |
| (Initial charge capacity per unit mass of | 1.51 | 1.39 | 1.11 |
| the negative electrode active material | | | |
| layer)/(Initial discharge capacity per | | | |
| unit mass of the negative electrode | | | |
| active material layer) [—] | | | |
| Cell capacity (mAh) | 4.4 | 4.9 | 6.2 |
| SOC 50% potential (V) | 3.58 | 3.63 | 3.67 |
| 10-second output (mW) | 497 | 465 | 446 |

### REFERENCE SIGNS LIST

10 positive electrode
30 negative electrode
12 positive electrode collector
32 negative electrode collector
12t, 32t tab portion
14 positive electrode mixture layer
34 negative electrode mixture layer
20 separator
16, 36 lead
70 case
100 lithium ion secondary cell

1. A lithium ion secondary cell comprising:
a negative electrode mixture layer containing 5 to 45% by mass of at least one negative electrode active material selected from the group consisting of hard carbon, soft carbon, Sn, Sn alloys, Si, Si alloys, SiOₓ (0<x<2), Ge, Ge alloys, carbon nanotubes, and carbon nanofibers; and
a positive electrode mixture layer containing a lithium-containing transition metal oxide,
wherein the negative electrode mixture layer satisfies the following formula:
(Initial charge capacity per unit mass of the negative electrode mixture layer)/(Initial discharge capacity per unit mass of the negative electrode mixture layer)≧1.3

2. The lithium ion secondary cell according to claim 1, wherein the negative electrode mixture layer further contains 105 to 500 parts by mass of graphite based on 100 parts by weight of the negative electrode active material.

3. The lithium ion secondary cell according to claim 1, wherein the negative electrode active material is SiOₓ (0<x<2).

4. The lithium ion secondary cell according to claim 2, wherein the negative electrode active material is SiOₓ (0<x<2).
